(19) United States
(12) Patent Application Publication
(10) Pub. No.: US 2011/0040630 A1
(43) Pub. Date: Feb. 17, 2011

(54) METHOD AND SYSTEM FOR MATCHING BORROWERS AND LENDERS

(75) Inventor: ADAM WEISS, New York, NY (US)

Correspondence Address: MCGUIREWOODS, LLP, 1750 TYSONS BLVD, SUITE 1800, MCLEAN, VA, 22102, US

(73) Assignee: Credit Online Ventures, Inc., Los Angeles, CA (US)

(21) Appl. No.: 12/852,151

(22) Filed: Aug. 6, 2010

Related U.S. Application Data
(60) Provisional application No. 61/231,904, filed on Aug. 6, 2009.

(51) Int. Cl. G06Q 30/00

(52) U.S. Cl. 705/14.66

(57) ABSTRACT

A computerized method for providing targeted offers to a subset of a plurality of users. The method comprises receiving offer data from an offerror, receiving a filtering parameter for the offer data, generating an offerror profile, which includes the offer data and the filtering parameter; comparing the offerror profile to a plurality of user profiles; determining a matching user profile from the plurality of user profiles; and forwarding an offer to a user account that is associated with the matching user profile, wherein the offer data includes the offer.

### CROSS REFERENCE TO PRIOR APPLICATIONS

This application claims priority and the benefit thereof from U.S. Provisional Patent Application No. 61/231,904, filed on Aug. 6, 2009, the entirety of which is hereby incorporated herein by reference.

### FIELD OF THE DISCLOSURE

The present disclosure relates to a method, a system and a computer program for providing offers for various financial products or services to specifically targeted groups of individual users, utilizing a range of screens and filters based on user-provided financial and demographic data to match offers to the targeted groups.

### BACKGROUND OF THE DISCLOSURE

A number of websites exist that advertise or offer credit cards to consumers. Most of these sites tend to flood consumers with credit card offers that may not be a good match to the particular consumers' needs or their particular financial situation or condition. Frequently, many of the consumers that receive the offers do not qualify for the offered credit cards, or the terms and conditions of the cards do not match the consumers' needs.

The present disclosure provides a method, a system and a computer program for providing offers for various financial products or services to specifically targeted groups of individual users based on user-provided financial and demographic data.

### SUMMARY OF THE DISCLOSURE

A method, a system and a computer program are disclosed for providing offers of various financial products and/or services to specifically targeted groups of individual consumers utilizing a range of screens and filters based on consumer (of user) provided financial and demographic data and a matching system to deliver the targeted offers to the targeted groups.

According to an aspect of the disclosure, the method and system for creating and providing “targeted” offers to users comprise: a user accessing a website; providing a data entry template to the user on the website, wherein the data entry template includes a plurality of demographic and financial questions (for example, 8-10 questions) and a plurality of data entry (or selection) fields; receiving the user's answers to the plurality of demographic and financial questions; and updating the user profile to include the user's answers to the plurality of questions. The method and system may further include generating a user request for various financial products and/or services, including, for example, a balance transfer, a payday loan, a debt consolidation, or a credit card request;

The method and system may further comprise: creating a user account for the user, including a user profile based on the user's answers to the plurality of demographic and financial questions; and storing the user's contact and access information (for example, email address, login ID, password), including the associated user profile. Based on the contact and access information, the user may access his/her offers, track and manage the offer response process, including, for example, sorting and comparing offers, applying for offers, holding offers for later review, and the like.

If it is determined that a user account exists for the user, the method and system further comprise: retrieving the user account and receiving updates to the user profile; receiving updates to prior offer response activity; managing offers, including tracking the offer response process (for example, sort and compare offers, apply for offers, hold offers for later review, and the like), and responding to new and previously unviewed offers, including, for example, rejecting one or more offers, keeping one or more offers on hold, or accepting one or more offers. The method and system may further comprise: querying a returning user as to the status of any one or more of the offers the user applied for in a prior session; and updating the user account for the returning user to include the user's response to the query. The method and system may further comprise validating payment by the offeror that is associated with the one or more offers the user applied for in the prior session.

The method and system may further comprise: utilizing a matching system to compare user profiles to existing offers; presenting matching offers to those user profiles that meet the criteria established by the offerrors for each particular offer, together with a description of each offer, as well as a link to the website of the offerror to facilitate the transaction, including, for example, an online application on the website of the associated offerror. This may be regarded as an on-screen “QUICK” or “INSTANT” search and match aspect of the disclosure, which may be implemented for new users or users with updated profiles. The method and system may further comprise: updating the user profile; and storing the updated user profile.

The method and system further comprise: receiving various offers from the offerrors (for example, invitations to apply, offers of payday loans, debt consolidation services, or the like); and generating a notification of such offers and sending the notification to the group of users meeting the criteria of the offers through each individual user's account, thereby notifying each matching user of such offers; and presenting one or more of the offers to each matching user, whereby the matching user may accept, or hold for later consideration, one or more of the offers. This may be regarded as a “PINGING” method or system, whereby one or more user profiles may be passively exposed to new offers, or existing offers which have one or more criteria that have changed and now include one or more users not previously included.

The method and system may further comprise providing each user with an ability to track and manage various applications and offers, and to keep a profile available to further offerrors of products and/or services based on the user profile and updated offer criteria.

The plurality of filter parameters selected by the offerror may comprise any one or more of the following: length of credit history, zip code, employment status, education, income, home ownership status, banking relationships, credit background, including credit score, bankruptcy or foreclosure status, spending habits and behaviors, balance(s) owed on credit card(s), and the like.

According to a further aspect of the disclosure, a method and system are provided for creating and providing targeted consumers to offerrors. The method and system comprise: an offerror accessing a website; determining whether an offerror account exists for the offerror and providing an offer template to the offerror on the website, wherein the offer template includes a plurality of offers (i.e., products and/or services), or a plurality of fields for entering new offers. The method and system may further comprise receiving uploads of various information from an offerror about its financial products and/or services, which may be made up of a description of the product or service, together with its terms and conditions. The information about the offerror's products and/or services may be included in the offerror account. The method and system may further comprise: receiving at least one of an edit to an offer, a suspension of an offer, a deletion of an offer, or a change in one or more filtering parameters associated with the offer. The change in one or more filtering parameters may include establishing filters for each offer. The publishing offers may include publishing selected offers to the website. The edit to an offer may include selecting when an offer might be made available to users, and for how long (for example, the publishing and expiration dates). The filtering parameters may include a plurality of demographic and financial questions (for example, 8-10 questions, or more) and a plurality of data entry (or selection) fields; and updating the offerror template to include the changes to offers, including the updated filtering parameters.

The method and system may further comprise: analyzing potential user profiles for each offer by subjecting the offer criteria to the entire group of users to ascertain all matching user profiles (so called “pre-flight” of offers); publishing the offer together with its offerror-selected filters to the website; matching the filtered offers to user profiles; and sending electronic communication of offers to each of the matching user profiles via the user's account on the website.

The method and system may further comprise making the user profiles available to the offerror, such that whenever a new matching profile gets added, the system automatically “pulls” the matching offer from the offerror to the matching user account.

The method and system may further comprise: providing the user access to his/her account, and receiving a user election of acceptance, rejection or hold of an offer; and providing the user with a link to the offerror associated with the accepted offer, which may link the user to, for example, an online application at a website of the offerror.

The filtering parameters, which may be used to determine inclusive or exclusive recipient lists, may comprise any one or more of the following: length of credit history, state, zip code, employment status, education, income, home ownership status, banking relationships, credit background, credit score, bankruptcy or foreclosure status, spending habits and behaviors, balance(s) owed on credit card(s), and the like.

According to a further aspect of the disclosure, in addition to being able to target an offer for a product and/or service to a specific user, a specific group of users, or the like, a particular user, particular group of users, or the like, may be blocked out. For example, an offerror may choose to not provide any offers of products and/or services to, for example, residents of a particular state, zip code, area code, or any other offerror-defined filters.

According to a further aspect of the disclosure, a computerized method is disclosed for providing targeted offers to a subset of a plurality of users. The method comprises: receiving answers to a plurality of demographic and financial questions; generating a user profile that includes said answers; and matching the user profile to an offerror profile. The method may further comprise providing a data entry template that comprises a plurality of fields configured to receive the answers to the plurality of demographic and financial questions. The plurality of fields may comprise between 8 and 10 fields, each of which is configured to receive a single answer to the plurality of demographic and financial questions.

The computerized method may further comprise: monitoring user behavior associated with the user profile; and generating user behavior parameters based on the user behavior, wherein the user behavior includes at least one of: a number of user profile updates; a number of offer applications approved by offerrors; and a number of offer applications rejected by offerrors. Matching the user profile to the offerror profile may comprise: comparing the user profile to a plurality of offerror profiles, including said offerror profile; determining said offerror profile as being a matching offerror profile; and forwarding an offer associated with the matching offerror profile to a user account that is associated with the user profile.

The computerized method may further comprise: displaying a user account that is associated with the user profile, wherein the user account comprises an offer management menu display. The offer management menu display may comprise: an offer identification of an offer, including terms and conditions associated with the offer; and a status indication for the offer. The status indication may comprise: a hold offer for later review status; a reject offer status; or an apply for offer status.

The computerized method may further comprise: displaying an offer management menu; monitoring user activity related to an offer; and updating the user account to include actions taken by the user related to the offer. The computerized method may further comprise providing a link to the user, wherein the link is associated with the offer.

According to a still further aspect of the disclosure, a computerized method is disclosed for providing targeted offers to a subset of a plurality of users. The method comprises: receiving offer data from an offerror; receiving a filtering parameter for the offer data; generating an offerror profile, which includes the offer data and the filtering parameter; comparing the offerror profile to a plurality of user profiles; determining a matching user profile from the plurality of user profiles; and forwarding an offer to a user account that is associated with the matching user profile, wherein the offer data includes the offer. The filtering parameter may comprise at least one of: length of credit history; a state of residency; a zip code; an employment status; an education level; an income amount or range; a home ownership status; a bank account status; a credit background; a credit score; a bankruptcy status; a foreclosure status; a spending habit; a spending behavior; a balance owed on a credit card; and a balance owed on all credit cards. The offer data may comprise information about financial products or services, including associated terms and conditions.

The computer method may further comprise: receiving an edit instruction from the offerror to edit the offer data; receiving a suspension instruction from the offerror to suspend the offer; or receiving a delete instruction from the offerror to delete the offer.

The computer method may further comprise: receiving an edit instruction from the offerror to edit the filter parameter; receiving a delete instruction from the offerror to delete the filter parameter; or receiving an add instruction from the offerror to add another filter parameter. The computer method may also comprise determining a potential demand for the offer. The determining the potential demand for the offer may comprise preflighting the offerror profile to the plurality of user profiles before publishing the offer.

According to a still further aspect of the disclosure, a system is disclosed for creating and providing targeted offers to users. The system comprises: a user interface that is configured to receive user data and generate a user account, including a user profile; an offerror interface that is configured to receive offerror data and generate an offerror account, including an offerror profile; and a matching system that is configured to compare the user profile with the offerror profile and provide an offer to the user account when a match is determined. The user data may comprise at least one of: a length of credit history; a state of residency; a zip code; an employment status; an education level; an income amount or range; a home ownership status; a bank account status; a credit background; a credit score; a bankruptcy status; a foreclosure status; a spending habit; a spending behavior; a balance owed on a credit card; and a balance owed on all credit cards. The system may be further configured to: monitor user behavior associated with the user profile; and generate user behavior parameters based on the user behavior, wherein the user behavior includes at least one of: a number of user profile updates; a number of offer applications approved by offerrors; and a number of offer applications rejected by offerrors.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for creating and providing targeted financial product and/or service offers to users, as well as for providing targeted consumers to offerrors, according to principles of the disclosure;

FIG. 2 shows an example of a matching system, according to principles of the disclosure;

FIG. 3 shows an example of a process for matching user profiles to offerror profiles and providing targeted offers to users of matching user profiles;

FIG. 4 shows an example of a process for providing targeted financial products and/or services to users;

FIG. 5 shows an example of a process for disseminating offers and providing targeted consumers to offerrors;

FIG. 6 shows an example of a user data entry template, according to principles of the disclosure;

FIG. 7 shows an example of the user data entry template of FIG. 6, including an example of user provided data;

FIG. 8 shows an example of an offer management template, according to principles of the disclosure; and

FIG. 9 shows an example of a filter management template, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a smart telephone, a cellular telephone device, a satellite telephone device, a cordless telephone, a software defined radio (SDR), a two-way radio, a personal data assistant (PDA), a mobile computer, a stationary computer, mobile station, a game console, a game controller, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

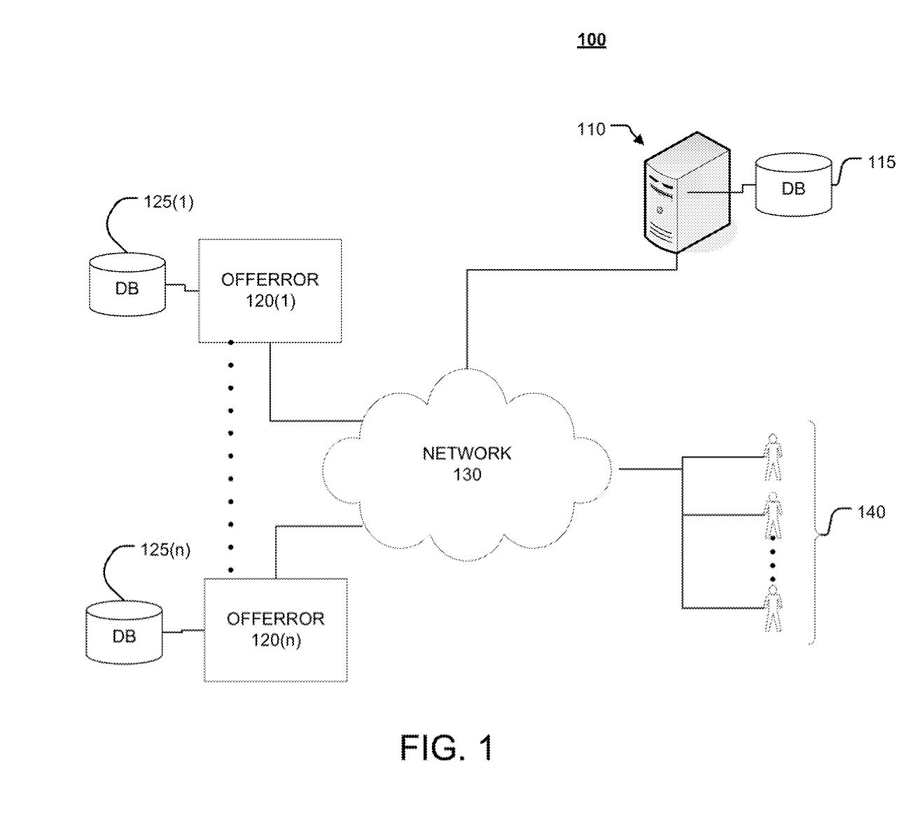

FIG. 1 shows an example of a system 100 for creating and providing targeted financial product and/or service offers (such as, for example, credit cards, credit lines, and the like) to a plurality of users 140, as well as a targeted subset of the plurality of users 140 to a plurality of offerrors 120(1) to 120(n), where n is a positive integer having a value greater than 1. The system 100 comprises a service provider server (SPS) 110, the plurality of offerrors 120(1) to 120(n), a network 130 and the plurality of users (or offerrees) 140. The SPS 110 may include one or more databases 115. Each of the offerrors 120 may include a database 125 (for example, 125(1) to 125(n)) and a server (not shown). The offerrors 120, the users 140, and the SPS 110 may each include a computer (not shown). The database(s) 115 may include third party databases, such as, for example, Google™, Facebook™, Twitter™, Yahoo™, and the like, which may have been populated with searchable user data that may be searched and matched based on filtering parameters.

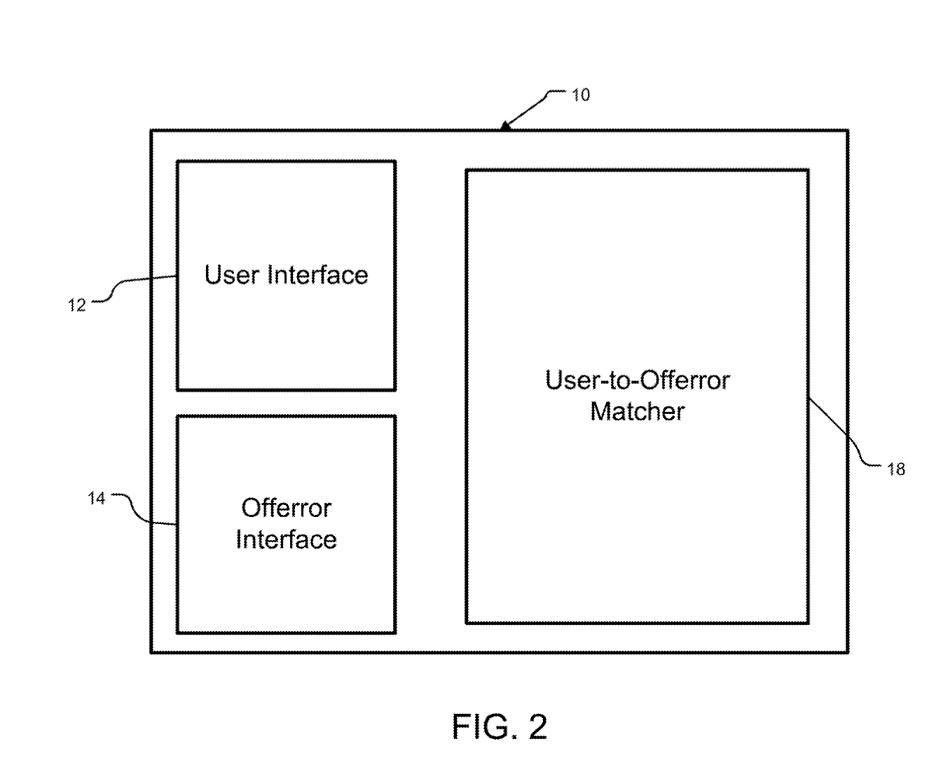

FIG. 2 shows an example of a matching system 10, according to principles of the disclosure. The matching system 10 includes a user interface (UI) system 12, an offerror interface (OI) system 14, and a user-to-offerror matching (UOM) system (or matcher) 18. The matching system 10 may be provided in the SPS 110 (shown in FIG. 1).

The UI system 12 is configured to interface and communicate with one or more of the plurality of users 140 (shown in FIG. 1). For each of the users 140, the UI system 12 is configured to: create and maintain a user account, including, for example, an email address, a password, a login ID, and a user profile; receive and process data from the user; receive and process instructions from the user; send offer data to the user; receive or create messages; maintain messages; monitor user activity; and the like. The user instructions may include offer selections, such as, for example, “APPLY”, “HOLD”, or “REJECT” for each offer presented to the user 140. The UI system 12 may facilitate redirecting the user 140 to a particular website of an offerror 120 whose offer the user 140 elected to apply for by, for example, selecting an “APPLY” radio button. The user accounts, including user profiles, may be stored in the database(s) 115 and/or the server 110 (shown in FIG. 1).

The OI system 14 is configured to interface and communicate with the plurality of offerrors 120. For each offerror 120, the OI system 14 may create and maintain an offerror account, which includes an offerror profile; receive and process product and/or service offerings of the offerror; receive and process instructions from the offerror; send user profile data to the offerror, and the like. The offerror profile includes offer data and filter parameters. The offer data includes information related to product and/or services offered by the offerror, including terms and conditions related to the products and/or services. The offerror instructions may include, for example, one or more filter categories to be applied to the user profiles, one or more filter parameters to be applied to the user profiles, and the like. The filter categories may include, for example, length of credit history, location, employment status, education level, income, home ownership status, bank account status, credit score status, and the like. The filter parameters may include, for example, specific values or ranges of values for each filter category.

The UOM system 18 is configured to search and analyze all of the user profiles for the users 140, which may be stored in the database 115 (shown in FIG. 1), and compare the user profiles with one or more offerror profiles, including filter categories and filter parameters, to identify matching user profiles. The UOM system 18 is further configured to generate and send matching offer messages to the user accounts of a subset of the plurality of users 140 whose user profiles are found to match the offerror profiles. Additionally (or alternatively), the UOM system 18 may be further configured to communicate with the UI system 12 to generate and send matching offer messages directly to the subset of users 140 whose user profiles match the offerror profiles. The offer messages may be sent in the form of an email message, an instant message (IM), a SMS message, a pop-up, a banner ad, or the like. Additionally (or alternatively), the UOM system 18 may be further configured to communicate with the UI system 12 to generate and send matching offer messages directly to only user 140 that match a predetermined behavior criteria. The behavior criteria may include, for example, those users 140 that have applied to and been approved for a set number of offers that they have applied for; those users 140 who have been rejected for more than a set number of offers that they have applied for; those users 140 that have not applied for any offers; or the like. The matching offer messages may include one or more products and/or services offered by the offerrors 120 whose filter categories and filter parameters match the subset of user profiles.

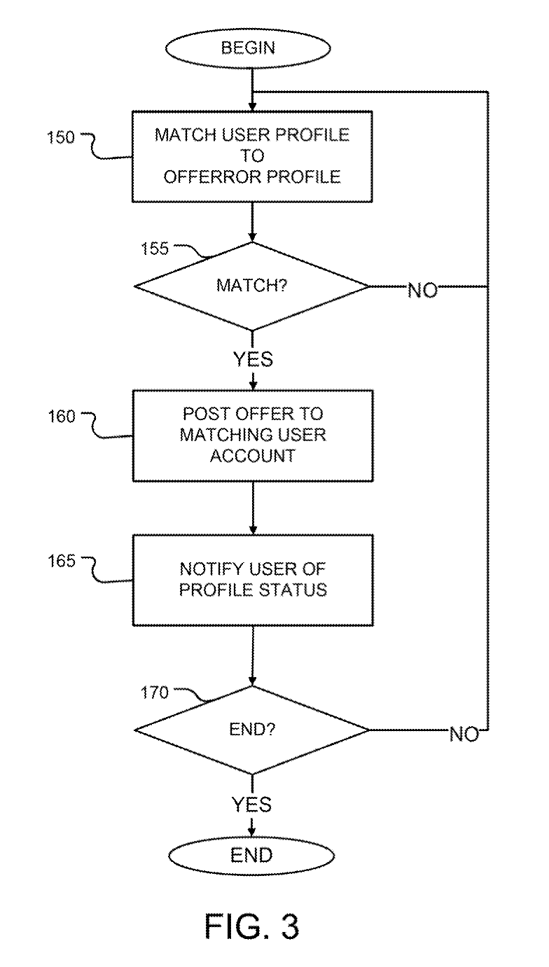

FIG. 3 shows an example of a process that may be carried out by the UOM system 18 (shown in FIG. 2) to match the user profiles of the plurality of user 140 to the offerror profiles of the offerrors 120 and provide targeted offers to those user accounts whose user profiles match the filter categories and filter parameters in the offerror profiles of the offerrors 120.

Referring to FIGS. 1-3, the matching system 10 may execute one or more sections (or segments) of code read from a computer readable medium (for example, on the SPS 110) to carry out the process shown in FIG. 3. The UOM system 18 compares a plurality of user profiles stored in the database(s) 115 (or user profiles provided in substantially real-time) to the offerror profiles stored, for example, in the database(s) 115 (or offerror profiles provided in substantially real-time) (Step 150). The user profiles may have been populated in the database(s) 115 with data received during interactive sessions between the UI system 12 and the users 140, and/or the user data received from an existing database, such as, for example, Google™, Facebook™, Twitter™, Yahoo™, and the like.

If a match is found (YES, Step 155), then the associated offer is posted to the user account of the matching user profile (Step 160), otherwise the process continues to match the user profiles to the offerror profiles (NO, Step 155). After the offer is posted to the user account (Step 160), the user is notified (“pingged”) of the addition of the offer to the user's account (Step 165). The user may be notified by an email message, a text message, an audio message, or the like, which may be generated and sent by the UI system 12 (shown in FIG. 2). A determination may be made whether to end the process, such as, for example, during maintenance (Step 170). The default may be set to continuously match user profiles to offerror profiles and update user accounts. Unless a determination is made to end the process (YES, Step 170), the system 100 may continue to match user profiles to offerror profiles and forward offers to those users 140 whose user profiles are found to match the filter categories and filter parameters provided in the offerror profiles (NO, Step 170).

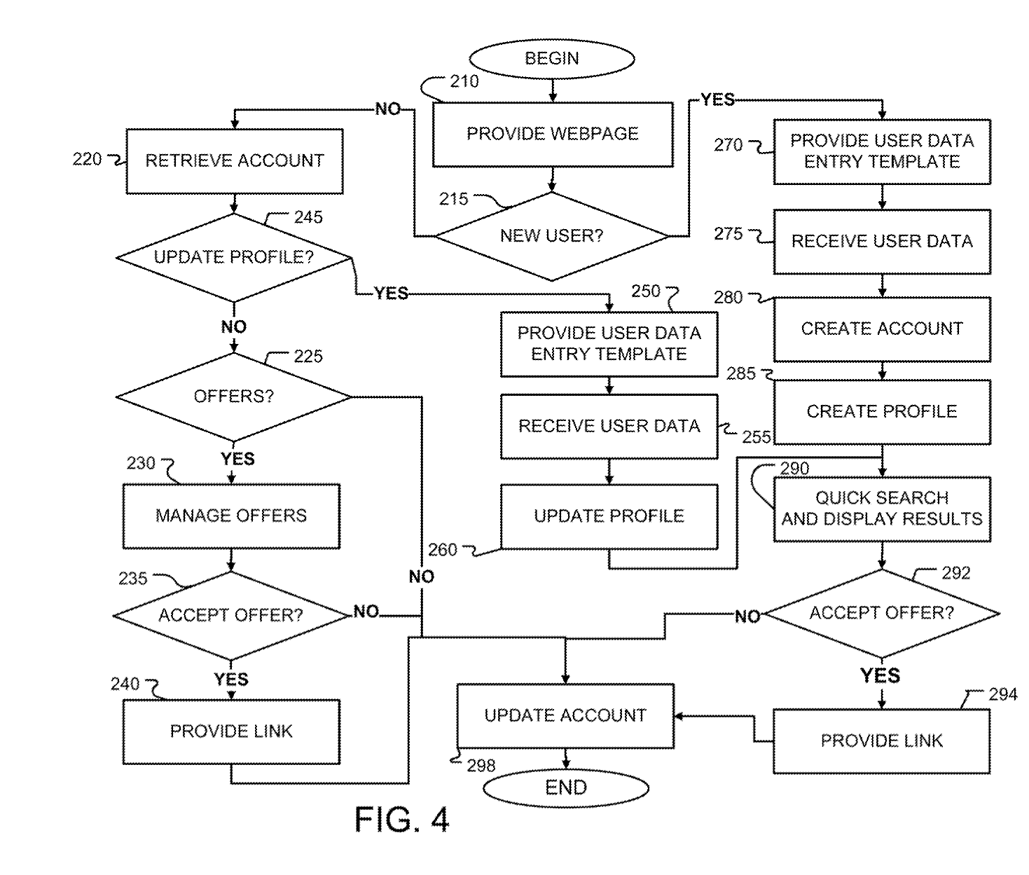

FIG. 4 shows an example of a process for providing targeted financial products and/or services to the users 140. Referring to FIGS. 1-2, the matching system 10 may execute one or more sections (or segments) of code read from a computer readable medium (for example, on the SPS 110) to carry out the process shown in FIG. 4. Initially, a website (or webpage) may be created, maintained and made available to the users 140 over the network 130 (Step 210). After a user 140 accesses the website and a session is initiated via, for example, the UI system 12, a determination may be made whether the user 140 is a new user or an existing user (Step 215).

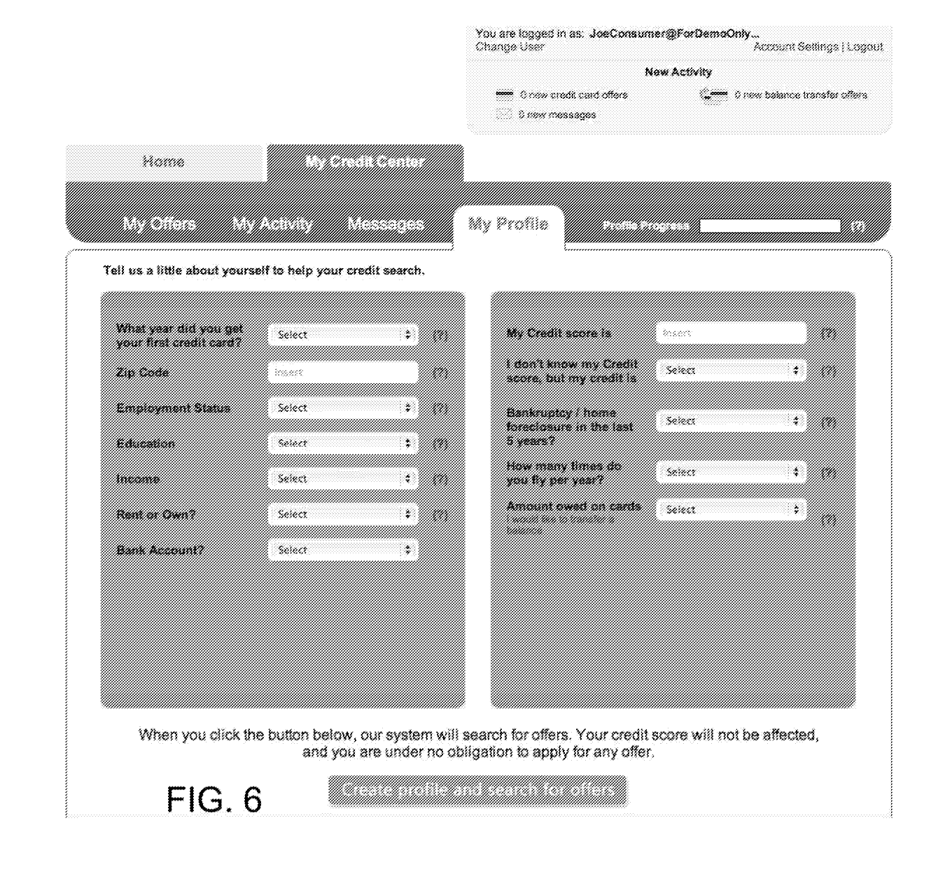

If it is determined that the user 140 is not a new user (NO, Step 215), then the user account associated with the user 140 may be retrieved by the UI system 12 from the database 115 (Step 220). On the basis of the user account, a determination may be made whether a user profile associated with the user account is to be updated (Step 245). If it is determined that a user profile associated with the user account should be updated (YES, Step 245), then the UI system 12 may provide the user 140 with a data entry template (such as, for example, the “My Profile” template shown in FIG. 6) (Step 250), otherwise a determination may be made whether offers for products and/or services exist for the user 140 in the associated user account, including, for example, but not limited to, offers the user 140 has not reviewed, offers that the user 140 has reviewed, offers that the user 140 has reviewed and put on hold, offers the user 140 has reviewed and rejected, and the like (NO, Step 245, Step 225).

The answers provided by the user 140 in response to the plurality of questions on the data entry template (such as, for example, length of credit history, state, zip code, employment status, education, income, home ownership status, banking relationships, credit background (including, for example, credit score), bankruptcy or foreclosure status, balance(s) owed on credit card(s), and the like) may be received and processed by the UI system 12 (Step 255). The UI system 12 may then update the user profile with the newly received information from the user 140 (Step 260).

Additionally, the user may provide requests for various financial products and/or services and the user profile may be updated to include the user requests, including, for example, a balance transfer, a payday loan, a credit request, and the like. In this regard, the user requests may be provided by the user 140 in, for example, one or more fields in the user data entry template, or it may be generated automatically based on the answers provided by the user 140 to the plurality of questions, including, for example, but not limited to, length of credit history, state, zip code, employment status, education, income, home ownership status, banking relationships, credit background, credit score, bankruptcy or foreclosure status, balance(s) owed on credit card(s), and the like.

If it is determined that one or more offers exist in the user account (for example, including offers that the user 140 has reviewed, offers that the user 140 has reviewed and put on hold, offers that the user 140 has reviewed and rejected, offers that the user 140 has accepted, and the like) (YES, Step 225), then a webpage comprising offers associated with the user account may be displayed to the user 140 and the user may be allowed to manage the offers by, for example, reviewing one or more offers, rejecting one or more offers, putting (or keeping) a hold on one or more offers, or accepting one or more offers, and the like (Step 230).

It is noted that the user 140 may be able to elect to apply for any of the offers associated with the user account, including, for example, offers that the user 140 has previously rejected, offers that the user has placed on hold, offers that the user has not yet reviewed, and the like.

If the user 140 has elected to reject an offer (Step 230), then the offer may be moved to a rejected offer category (for example, a “My Activity” tab).

If the user 140 has elected to hold an offer (Step 230), then the offer may be moved to a hold offer category (for example, the “My Activity” tab).

If the user 140 has elected to apply for an offer (Step 230, YES at Step 235), then the user may be provided with a message (for example, a pop-up, an email message, a SMS text message, or the like). The message may include, for example, a message notifying the user 140 with a user specific message, such as, for example, that the user's credit score may be impacted, that the user 140 is about to leave the website of the SPS 110, or the like.

A determination may be made whether the user 140 has elected to accept one or more of the offers (Step 235). If the user 140 has elected to accept a particular offer (YES, Step 235), then the user may be provided with a link (for example, a hyperlink, or the like), which the user 140 may use to access an online application at an associated offerror 120 via the network 130 (Step 240). The user account for the user 140 may then be updated to include the user's election to accept the particular offer, the link that was provided to the user, the time and date at which the user elected to accept the offer, and the like (Step 298).

After the user 140 has accessed the website of the particular offerror 120 through the provided link, the user 140 may be returned from the website of the particular offerror 120 and queried to determine whether the user 140 applied for a particular offer, or whether the user 140 changed his/her mind. Additionally (or alternatively), a user specific message may be provided to the user 140, such as, for example, a pop-up, a new window, a box, or the like. If the user 140 indicates that he/she has changed his/her mind, then the offer may be placed in a HELD offer category of the user account until the user 140 elects to reject the offer.

If a message is received from the particular offerror 120 that the application of the user 140 has been approved, declined, pending, or the like, the user account of the user 140 may be updated (STEP 298) to show the status of the application (for example, in the “My Activity” tab). If a message is not received from the particular offerror 120 after a predetermined time (for example, four days), then a message may be generated and sent to the user 140, prompting the user 140 to update the associated user account. The user behavior associated with a particular 140 may be monitored based on the messages received from the offerror 120. For example, the matching system 10 may keep track of the number of times the user has updated the user profile, the number of offer applications approved by offerrors for the particular user 140, the number of offer applications rejected by offerrors for the particular user 140, or the like. Based on the user behavior, a number of behavior parameters may be generated, which may include, for example, the number of user profile updates, the number of approved application offers, the number of rejected application offers, and the like, for each user 140.

If the user 140 elects not to accept any offers, or the user 140 makes changes to data in the user account (NO, Step 235), then the user account may be updated to include the user selections and/or changes (Step 298).

Based on the user profile, a quick search of existing offerror profiles on the database(s) 115 may be carried out and matching offers may be displayed to the user 140 for the consideration of the user 140 (Step 290). In addition to the matching offers found in the quick search, the user 140 may also review prior offers that the user 140 has not yet accepted, has put on hold, and/or has rejected (Step 290). If the user 140 elects to accept one or more of the matching offers (YES, Step 292), then a link may be provided to the user 140, which the user 140 may use to access an online application at a website of an associated offerror 120 via the network 130 (Step 294), otherwise the account for the user 140 may be updated to include the user's rejection of one or more offers, hold placed on one or more offers, or the like (NO Step 292, then Step 298). The activities (for example, viewing one or more offers, placing a hold on one or more offers, rejecting one or more offers, accepting one or more offers, or the like) by each user 140 may be monitored and noted by the UI system 12. Further, the user accounts associated with each user 140 may be updated to include the user's activities (Step 298).

If it is determined that the user 140 is a new user (YES, Step 215), then a user data entry template may be provided to the user (Step 270). The user data entry template may include fields for the user 140 to provide information such as, for example, a name, a mailing address, an email address, a telephone number, a login ID, a password, and the like. The user data entry template may further include a plurality of fields for providing demographic and financial information specific to the user 140 (as shown, for example, in FIG. 6, which includes, for example, twelve fields for demographic and financial information). The user data may be received from the user 140 (Step 275) and processed to create a user account for the particular user 140 (Step 280). The user data may further include requests for various financial products and/or services, including, for example, a balance transfer, a payday loan, a debt consolidation, or a credit card request; and updating the user profile to include the user requests. A user profile may be created for the user 140 based on the demographic and financial information provided by the user (Step 285).

If the user profile for a particular user 140 is less than complete by a predetermined threshold (for example, 70% complete), the particular user 140 may be prompted to more fully complete the data entry template (Step 270). In creating the user account (Step 280), the user 140 may be routed to account setting to, for example, establish notification settings.

Based on the user's profile, a quick search of existing offerror profiles on the database(s) 115 may be carried out and matching offers may be displayed to the user 140 for the user's consideration (Step 290). If the user 140 elects to accept or apply for one or more of the matching offers (YES, Step 292), then a link may be provided to the user 140, which the user 140 may use to access an online application at a website of an associated offerror 120 via the network 130 (Step 294), otherwise the account for the user 140 may be updated to include the user's rejection of one or more offers, hold placed on one or more offers, or the like (NO Step 292, then Step 298). The activities (for example, viewing one or more offers, placing a hold on one or more offers, rejecting one or more offers, accepting one or more offers, or the like) of the user 140 may be monitored and noted. In this regard, the user account associated with the user 140 may be updated to include the user's activities (Step 298).

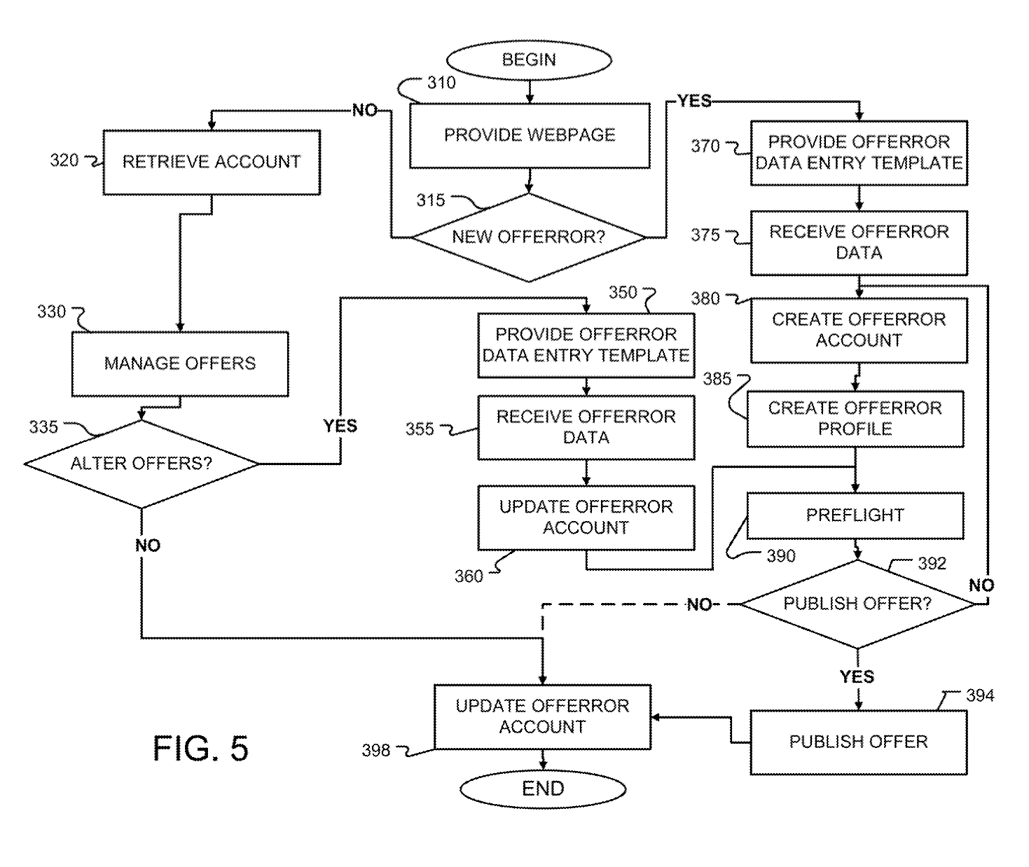

FIG. 5 shows an example of a process for providing a targeted subset of the plurality of users 140 to one or more offerrors 120, while providing targeted financial products and/or services to the users 140. Referring to FIGS. 1-2 and 5, the matching system 10 may execute one or more sections (or segments) of code read from a computer readable medium (for example, on the SPS 110) to carry out the process shown in FIG. 5. Initially, a website (or webpage) may be created, maintained and made available to the offerrors 120 over the network 130 (Step 310). After an offerror 120 accesses the website and a session is initiated between the offerror 120 and OI system 14, a determination may be made whether the offerror 120 is a new offerror or an existing offerror (Step 315).

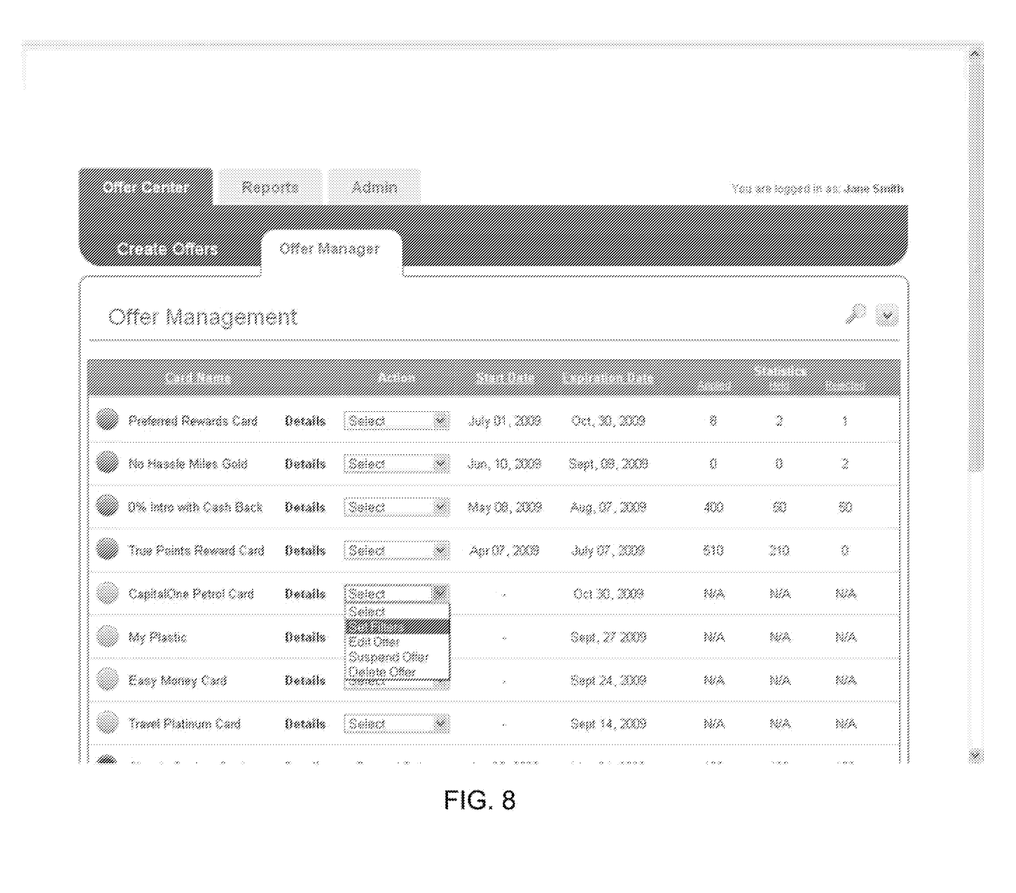

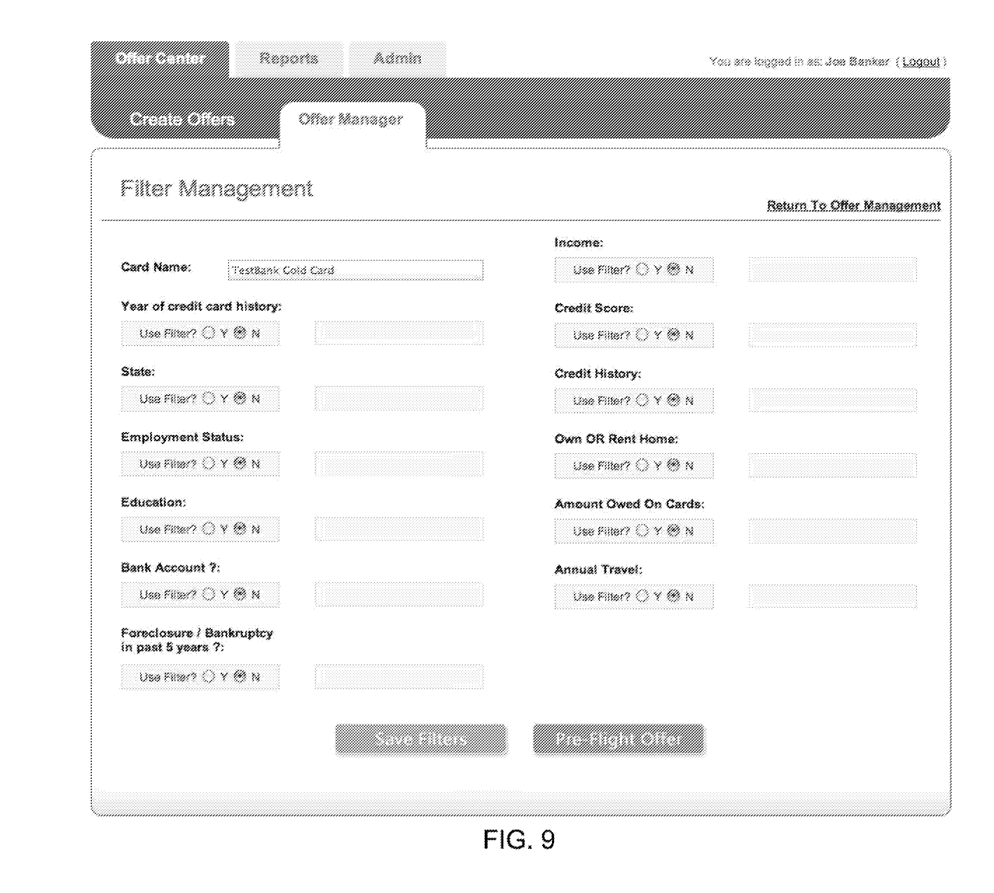

If it is determined that the offerror 120 is not a new offerror (NO, Step 315), then the OI system may retrieve an offerror account associated with the offerror 120, for example, from the database 115 (Step 320). On the basis of the offerror account, the OI system 14 may present an offer management template to the offerror 120, permitting the offeror 120 to manage existing offers, upload new offers, edit filtering criteria, set or edit publishing dates and durations, and the like (Step 330). For example, a webpage may be displayed to the offerror 120 comprising products and/or services currently offered by the offeror 120. FIGS. 8 and 9 show examples of offer management templates. The offerror 120 may be allowed to manage the offers by, for example, setting filter parameters, changing filter parameters, adding filter parameters, editing offers, suspending offers, adding offers, preflighting offers, republishing offers, deleting offers for each offer associated with the offerror 120, and setting and editing publishing dates (e.g., campaigns) for each offer (Step 330).

In the preferred embodiment of the disclosure, preflighting offers (in Step 330) comprises analyzing substantially all user profiles in the system 100 for a given offer prior to publishing the offer. The process of preflighting offers may include: uploading a particular offer to the OI system 14; uploading the terms of the offer (for example, requirements, restrictions, and the like) to the OI system 14; establishing or selecting filter parameters for the offer; and submitting a preflight request for the offer (for example, by selecting a “PREFLIGHT” icon or radio button) and displaying the number of matching user profiles. Additionally (or alternatively), the process of preflighting offers may include presenting a gross total of all matching user profiles. Optionally, the process of preflighting offers may include presenting a real-time, onscreen display of all matching user profiles. The offerror 120 may edit filters, re-preflight an offer, and the like, and then publish the offer to the SPS 110 (or website), including setting publish date and an expiration date for the offer.

A determination may be made whether the offerror 120 has made any changes to any of the data associated with the offerror's offered products and/or services (Step 335). If the offerror 120 has made changes (YES, Step 335), then an offerror data entry template (such as, for example, the filter management template, shown in FIG. 9) may be provided to the offerror 120 (Step 350), otherwise the offerror account may be updated (NO, Step 335, then Step 398).

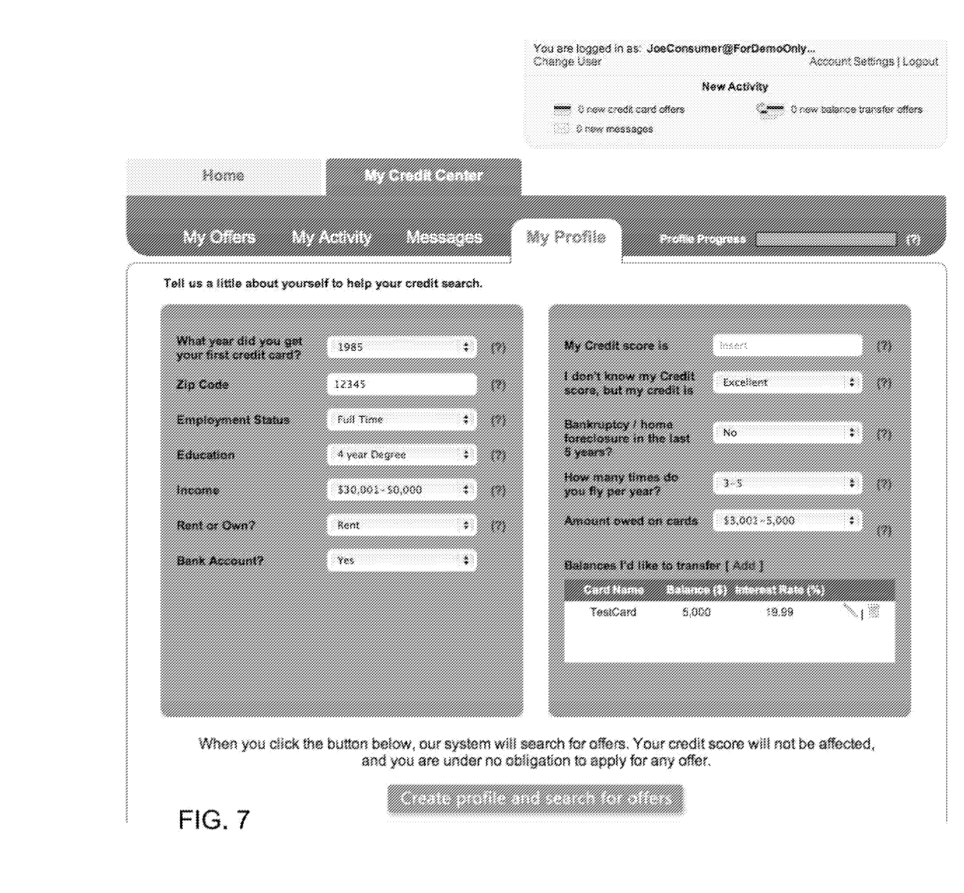

After the offerror selects one or more desirable filter categories (such as, for example, length of credit history, state, zip code, employment status, education, income, home ownership status, banking relationships, credit background, credit score, bankruptcy or foreclosure status, balance(s) owed on credit card(s), and the like, shown, for example, in FIG. 7), and sets corresponding filter parameters, the offerror's selections may be received and processed by the OI system 14 (Step 355). The offerror account associated with the offerror 120 may then be updated with the newly received information from the offerror (Step 360).

If it is determined that the offerror 120 is a new offerror (YES, Step 315), then the OI system 14 may provide an offerror data entry template to the offerror 120 (Step 370). The offerror data entry template may include fields for the offerror 120 to provide information such as, for example, a name, a mailing address, an email address, a telephone number, a login ID, a password, an account number, and the like. The offerror data entry template may further include a plurality of fields for uploading one or more offers, terms (for example, requirements, restrictions, etc.) for the one or more offers, start dates for the one or more offers, expiration dates for the one or more offers, filter parameters associated with the one or more offers, and the like (such as, for example, shown in FIG. 7). Additionally, the offerror data entry template may include fields for setting roles and permissions for individuals. The offerror data may be received from the offerror 120 (Step 375) and processed to create an account for the particular offerror 120 (Step 380). Further, based on the data entered by the offerror, an offerror profile may be generated for the particular offerror (Step 385).

Based on the offer data in the offerror's account, and after a particular offer, its terms, and the associated filter parameters have been uploaded to the OI system 14, potential demand for the offer may be analyzed (“preflight”) (Step 390). A determination may be made whether to publish one or more of the offers of the offerror 120 (Step 392). Further, a determination may be made whether to publish an offer and for how long to publish the offer for. The preflight is carried out using the offerror profile associated with the particular offerror account and comparing the offerror profile to substantially all, or a select subset of all user profiles.

If a determination is made to publish the offers (YES, Step 392), then the offer may be published together with its offerror-selected filters in the offerror account in the website (Step 394), otherwise the offerror 120 may be permitted to re-set filters (NO, Step 392, then Step 398). The offerror 120 may be permitted to set publishing dates, including, for example, when and for how long a particular offer may be available to be matched to user profiles (Step 394). Optionally, after the offerror 120 elects not to publish the offer (NO Step 392), the offerror's account may then be updated (Step 398).

It is noted that the system 100 collects user account data, including user profile data, for each of the users 140 and stores the data in, for example, the server 110 and/or the database(s) 115. The system 100 further collects offerror account data, which it also stores in the server 110 and/or database(s) 115. The system 100 matches the user profiles to the offerror accounts and sends targeted offers to one or more users associated with the matching user profiles.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed:

1. A computerized method for providing targeted offers to a subset of a plurality of users, the method comprising:
receiving answers to a plurality of demographic and financial questions;
generating a user profile that includes said answers; and
matching the user profile to an offerror profile.

2. The computerized method according to claim 1, further comprising:
providing a data entry template that comprises a plurality of fields configured to receive the answers to the plurality of demographic and financial questions.

3. The computerized method according to claim 2, wherein the plurality of fields comprise between 8 and 10 fields, each of which is configured to receive a single answer to the plurality of demographic and financial questions.

4. The computerized method according to claim 1, further comprising:
monitoring user behavior associated with the user profile; and
generating user behavior parameters based on the user behavior,
wherein the user behavior includes at least one of:
a number of user profile updates;
a number of offer applications approved by offerrors; and
a number of offer applications rejected by offerrors.

5. The computerized method according to claim 1, further comprising:
displaying a user account that is associated with the user profile, wherein the user account comprises an offer management menu display.

6. The computerized method according to claim 5, wherein the offer management menu display comprises:
an offer identification of an offer, including terms and conditions associated with the offer;
a status indication for the offer.

7. The computerized method according to claim 6, wherein the status indication comprises:
a hold offer for later review status;
a reject offer status; or
an apply for offer status.

8. The computerized method according to claim 1, wherein said matching the user profile to the offerror profile comprises:
comparing the user profile to a plurality of offerror profiles, including said offerror profile;
determining said offerror profile as being a matching offerror profile; and
forwarding an offer associated with the matching offerror profile to a user account that is associated with the user profile.

9. The computerized method according to claim 8, further comprising:
displaying an offer management menu;
monitoring user activity related to an offer; and
updating the user account to include actions taken by the user related to the offer.

10. The computerized method according to claim 9, further comprising:
providing a link to the user, wherein the link is associated with the offer.

11. A computerized method for providing targeted offers to a subset of a plurality of users, the method comprising:
receiving offer data from an offerror;
receiving a filtering parameter for the offer data;
generating an offerror profile, which includes the offer data and the filtering parameter;
comparing the offerror profile to a plurality of user profiles;
determining a matching user profile from the plurality of user profiles; and
forwarding an offer to a user account that is associated with the matching user profile,
wherein the offer data includes the offer.

12. The computer method according to claim 11, wherein the filtering parameter comprises at least one of:
length of credit history;
a state of residency;
a zip code;
an employment status;
an education level;
an income amount or range;
a home ownership status;
a bank account status;
a credit background;
a credit score;
a bankruptcy status;
a foreclosure status;
a spending habit;
a spending behavior;
a balance owed on a credit card; and
a balance owed on all credit cards.

13. The computer method according to claim 11, wherein offer data comprises:
information about financial products or services, including associated terms and conditions.

14. The computer method according to claim 11, further comprising:
receiving an edit instruction from the offerror to edit the offer data;
receiving a suspension instruction from the offerror to suspend the offer; or
receiving a delete instruction from the offerror to delete the offer.

15. The computer method according to claim 1 further comprising:
receiving an edit instruction from the offerror to edit the filter parameter;
receiving a delete instruction from the offerror to delete the filter parameter; or
receiving an add instruction from the offerror to add another filter parameter.

16. The computer method according to claim 11, further comprising:
determining a potential demand for the offer.

17. The computer method according to claim 16, wherein the determining the potential demand for the offer comprises:
preflighting the offerror profile to the plurality of user profiles before publishing the offer.

18. A system for creating and providing targeted offers to users, the system comprising:
a user interface that is configured to receive user data and generate a user account, including a user profile;
an offerror interface that is configured to receive offerror data and generate an offerror account, including an offerror profile; and
a matching system that is configured to compare the user profile with the offerror profile and provide an offer to the user account when a match is determined.

19. The system according to claim 18, wherein user data comprises at least one of:
length of credit history;
a state of residency;
a zip code;
an employment status;
an education level;
an income amount or range;
a home ownership status;
a bank account status;
a credit background;
a credit score;
a bankruptcy status;
a foreclosure status;
a spending habit;
a spending behavior;
a balance owed on a credit card; and
a balance owed on all credit cards.

20. The system according to claim 18, wherein the matching system is further configured to:
monitor user behavior associated with the user profile; and
generate user behavior parameters based on the user behavior,
wherein the user behavior includes at least one of:
a number of user profile updates;
a number of offer applications approved by offerrors; and
a number of offer applications rejected by offerrors.
